(19) United States
(12) Patent Application Publication
(10) Pub. No.: US 2003/0185522 A1
(43) Pub. Date: Oct. 2, 2003

(54) Bend limiter

(76) Inventors: Craig A. Young, Nazareth, PA (US); Duane S. Stackhouse, Coopersburg, PA (US)

Correspondence Address: MORGAN, LEWIS & BOCKIUS LLP, 1701 MARKET STREET, PHILADELPHIA, PA, 19103-2921, US

(21) Appl. No.: 10/114,339

(22) Filed: Apr. 2, 2002

(51) Int. Cl. G02B 6/36

(52) U.S. Cl. 385/86; 385/134; 385/92

(57) ABSTRACT

A bend limiter configured to interface with an elongated optical fiber to limit bending of the optical fiber. The bend limiter includes an elongated spring having a spirally extending coil that at least partially defines an inner bore. The inner bore is adapted to accommodate the optical fiber such that the spirally extending coil extends coaxially around the optical fiber. The elongated spring provides bending resistance that limits the bending of the optical fiber. In one aspect, the outer diameter of the bend limiter (formed from an elongated spring) can be constructed much smaller than current bend limiter outer diameters for optical devices.

### FIELD OF THE INVENTION

This invention relates to optical or electrical conductors, and more particularly to bend limiters to be used with optical or electrical conductors.

### BACKGROUND OF THE INVENTION

In optical systems, optical components optically connect to optical fibers. In electrical systems, electrical components electrically connect to electrical conductors. Using optical connections as an example, the optical fiber connecting to the optical device extends through a package. The package is configured to protect the optical device. Optical fibers and electrical wires are generally very fragile, and no segment of the optical fiber can be bent more than a prescribed limit without suffering significant damage or breaking (i.e., the maximum bend limit of the fiber.) Accordingly, a mechanism known as a bend limiter is provided to limit damage to the optical fiber. The bend limiter limits the bending of the optical fiber or electrical wire extending away from the package to within the maximum bend limit. Many embodiments of bend limiters are mechanically secured to the package to protect optical fiber or electrical wire extending through the package.

Installing the bend limiter to the package has its drawbacks, however. Many package dimensions are decreasing with advances in technology. A smaller package is preferred in many applications because it can fit in tight locations. There is no feasible technique to mount the bend limiter on a package that has a minimum height that is less than the minimum overall thickness of the bend limiter. However, many bend limiters have a minimum height that is dictated by manufacturing techniques. That is, many current bend limiters have a larger cross-sectional diameter than the height of certain optical packages, and as a result it becomes very difficult to secure those bend limiters to the packages. An additional facing to the package can provide a secure bend limiter mounting. Such an additional facing increases the miniaturized package dimension.

Providing a bend limiter that could be used with a package or housing in conjunction with optical fibers, electrical wires, or any other fragile elongated flexible members without adding any additional package size is desirable. Such bend limiters would limit the bend of the fragile elongated flexible members, and therefore limit resultant damage applied to the flexible member while adding no additional dimension to the package.

### SUMMARY OF THE INVENTION

The bend limiter interfaces with an optical fiber to limit bending of the optical fiber. The bend limiter includes an elongated spring. The elongated spring includes a spirally extending coil. The spirally extending coil at least partially defines an inner bore. The inner bore is adapted to accommodate the optical fiber such that the spirally extending coil extends coaxially around the optical fiber. The elongated spring provides bending resistance that limits the bending of the optical fiber.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain features of the invention.

FIG. 1 is a side partial cross-sectional view of a prior art embodiment of bend limiter secured to a package;

FIG. 2 is a side partial cross sectional view of a bend limiter similar to FIG. 1 that cannot be secured to a package because the bend limiter has a larger overall dimension than the dimension of the package;

FIG. 3 is a side view of one embodiment of bend limiter including a spring;

FIG. 4 is a side view of another embodiment of bend limiter including a spring;

FIG. 5 is a cross-sectional view, taken along sectional line 5-5 in FIG. 3, of one coil configuration;

FIG. 6 is a cross-sectional view, taken along sectional line 6-6 in FIG. 4 of another coil configuration;

FIG. 7 is a cross-sectional view, taken along sectional line 6-6 in FIG. 4 of another coil configuration from that shown in FIG. 6;

FIG. 8 is a side view of another embodiment of bend limiter;

FIG. 9 is a perspective view of another embodiment of bend limiter secured to a package, where an optical device is located within the package;

FIG. 10 shows a side cross-sectional view of one embodiment of bend limiter secured to a package;

FIG. 11 shows a side cross-sectional view of another embodiment of bend limiter secured to a package;

FIG. 12 shows a side cross-sectional view of yet another embodiment of bend limiter secured to a package;

FIG. 13 is a perspective view of one embodiment of a package having a baseplate and a backbone wherein the backbone interfaces with a bend limiter;

FIG. 14 is a perspective view of one embodiment of bend limiter secured to a backbone;

FIG. 15 is a top partial cross-sectional view of the package including the backbone; and

FIG. 16 shows side view of one embodiment of bend limiter undergoing bending to different radii of curvatures.

The embodiments of the present invention will be described hereto with reference to the accompanying drawings. The same or similar devices are represented by the same reference numerals in different ones of the figures.

### DETAILED DESCRIPTION OF THE EMBODIMENT

1. Bend Limiter Configurations

The present disclosure describes multiple embodiments of bend limiters. These multiple embodiments are illustrative and do not limit the scope of the invention as set forth in the claims.

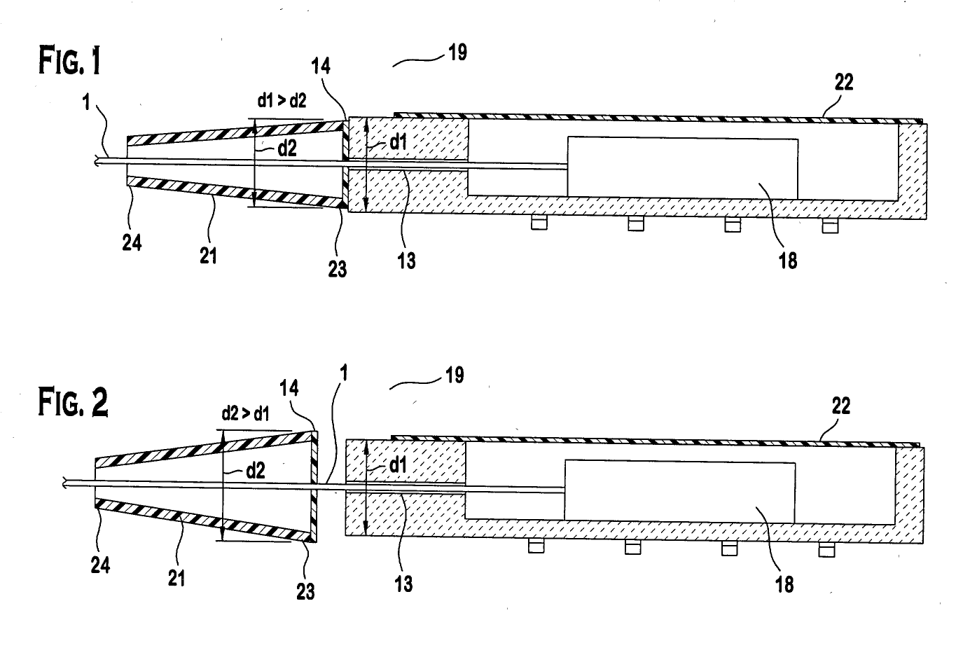

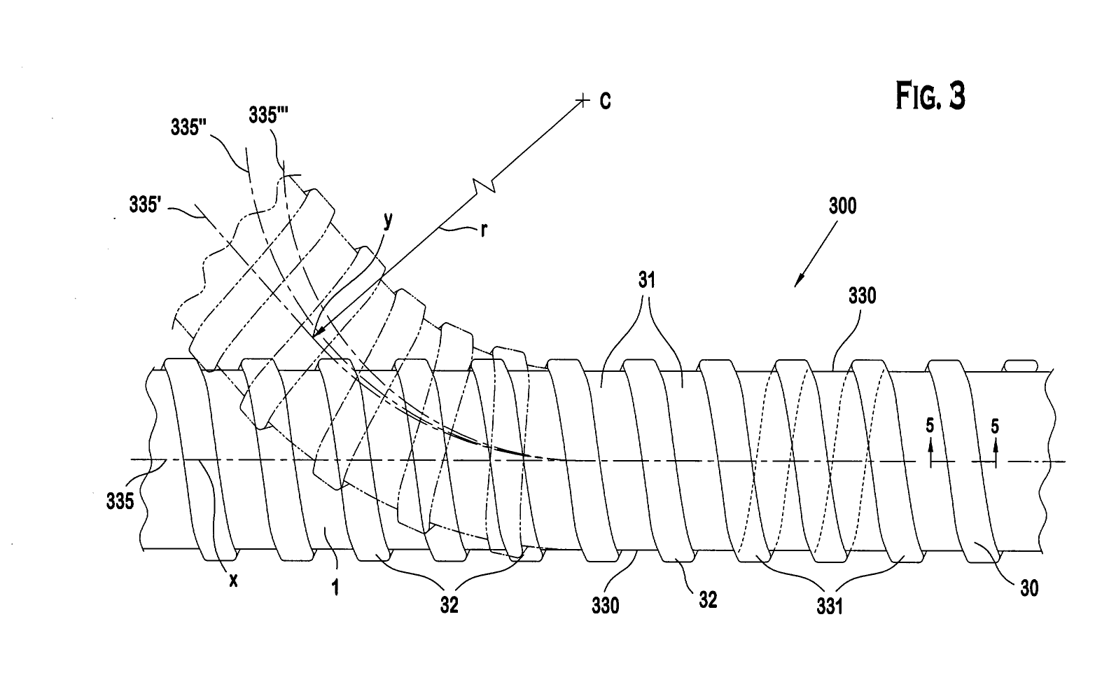

FIGS. 1 and 2 show prior art embodiments of connecting system 19. The connecting system 19 includes a package 22 that contains an optical or electrical device 18, an optical fiber 1 that extends through an aperture 13 formed in the package 22 to connect to the optical or electrical device 18, and a bend limiter 21. The bend limiter 21 extends circumferentially about the optical fiber 1. In FIG. 1, the bend limiter 21 connects via a mounting device 14 to an optical package 22. The bend limiter provides bending resistance of the optical fiber 1. The mounting device 14 may include a mechanical fastener or connector, an adhesive, or any other known device or material that can connect the bend limiter 21 to the package 22. The bend limiter 21 has an outer fiber end 24 from which optical fibers extend, and a mounting end 23 that connects to the package 22. The bend limiter 21 shown in FIG. 1 is suited to those instances where the dimension d1 of the package 22 exceeds the dimension d2 of the bend limiter 21.

However, when any dimension d2 of the bend limiter 21 exceeds the dimension d1 of the package 22, as shown in FIG. 2, the mounting device 14 cannot secure the mounting end 23 of the bend limiter 21 to the package 22. This dimensional limitation results because no portion of the package 22 exists adjacent to the mounting end 23 of the bend limiter 21. Some portion of the package 22 has to provide a secure mounting for the mounting end 23 of the bend limiter 21. The minimum overall dimension d2 of the mounting end 23 of the bend limiter 21 thus determines the minimum dimension d1 of the package 22.

Where the dimension d2 of the bend limiter exceeds the dimension d of the package, an additional piece of material providing an increased dimensional region attached to the package could provide a mounting surface for the bend limiter. Such an increased region, however, would require additional machining, and additionally produce a stress concentration region relative to the material of the package. Most current bend limiters are molded using a silicone rubber, or a polymer material. As such, a minimal wall thickness is necessary to mold these bend limiters, thereby necessitating the minimum overall dimension d2 of the bend limiter. Using common molding techniques, etc., the dimension d2 of a bend limiter can only be molded above a prescribed minimum distance while still maintaining the desired wall thickness of the bend limiter. As shown in FIG. 2, it is not known how to make a bend limiter smaller than a dimension of a miniaturized package, due to minimum wall thickness requirements for molding. In general, the bend limiter has a finite cross-sectional diameter to provide sufficient resistance against bending. If the bend limiter is too thin, it will not have sufficient resistance against bending strain when applied against the fiber; additionally, the bend limiter may break from overstress or structural fatigue within a relatively brief lifetime. The dimensions d1 and d2 correspond to a side view of the package 22. The relation describing the bend limiter 21 not being solidly secured to the package 22 (if d2 exceeds d1) applies in all directions perpendicular to the bend limiter's longitudinal axis.

Additionally, as shown in FIGS. 1 and 2, the diameter of the outer fiber end 24 of the bend limiter 21 is smaller than that of the mounting end 23. In addition, the mounting device 14, located in the mounting end 23 for securing the mounting end 23 to the package 22, has a larger diameter than the mounting end 23. Thus, the cross-sectional diameter is relatively small towards the outer fiber end 24 and gradually increases towards the mounting end 23. Because of this design, a bending resistance afforded by the prior type bend limiter may not be sufficient at or near the outer fiber end 24 (or at or near the mounting end 23). This bending resistance increases the risk of damage to the bend limiter, and results in a corresponding change to an unprotected optical fiber.

It is possible not to use any bend limiters, or other strain reliever, on optical fibers (and electrical conductors) exiting and/or entering the package. In those embodiments that do not include a bend limiter, however, a bending force applied to the fiber will have an increased risk of damaging or breaking the optical fiber. As a result, in optical packages without bend limiters 21, installer and operators of the connecting system 19 have to be gentle and careful in handling the optical fiber to limit damage to the optical fiber.

Multiple embodiments of bend limiter described herein address these design limitations. The embodiment of bend limiter 300 as shown in FIG. 3 can protect optical or electrical conductors emanating from communication or computer systems. While the bend limiter 300 is described relative to an optical communication or computer system, any type of communication or computer system can include a bend limiter. The different types of communication or computer system relate to electronic, electric, hybrid, etc. that may also use bend limiters 300 as described herein. Additionally, while bend limiters may be used to protect optical fibers, bend limiters may also be used to protect delicate electrical wires.

Referring to FIG. 3, the bend limiter 300 includes an elongated spring 30. The spring 30 comprises a spirally extending coil 32. The coil 32 partially defines an inner bore 31 of the spring 30. The inner bore 31 has a generally cylindrical shape 328 (in cross section) generated by lines 330 that contact the innermost points of each spirally extending coil. The inner bore 31 extends substantially parallel to the longitudial axis of the bend limiter in such a manner that each of the lines 330 form a tangent with each coil of the spring at an innermost point 331 of each respective coil. The radius of curvature of the bend limiter 300 may change as lateral forces are applied thereto, and as such, the lines 330 and the cylindrical shape become curved (follows an arc) in a manner that the arc substantially follows but is spaced from, the longitudinal axis of the bend limiter. FIG. 16 shows how the radius of curvature changes as the bend limiter 300 undergoes bending. The longitudinal axis of the bend limiter 300 shifts from its initial state 335 (that is illustrated as straight, although it may be curved in certain embodiments) to progressively increasing bent states 335′, 335″, and 335′″. These increasing bent states 335′, 335″, and 335′″ illustrate the position when greater lateral forces are applied to the bend limiter 300. Removing the applied bending forces causes the bend limiter to return to its initial, undeflected, state 335.

Geometrically, the radius of curvature r′, r″ or r′″ of the bend limiter may be considered relative to a circle matching the radius of curvature and having a center at point C′, C″ or C′″, respectively. The bend limiter has no bend and an infinite radius of curvature if the longitudinal axis 300 of the bend limiter 300 is geometrically coincident with a line (and not an arc of a circle). As a sufficient force is applied to the optical fiber located in the bend limiter, the bend of the bend limiter increases so the axis 335′ of the bend limiter is coincident with an arc of a circle centered at C′ and having a radius of curvature of r′. As a progressively greater force is applied to the optical fiber located in the bend limiter, the bend of the bend limiter is further increased so the axis 335″ of the bend limiter is coincident with an arc of a circle centered at C″ and having a radius of curvature of r″. As still further force is applied, the radius of curvature further decreases to r′″.

As the force applied to the bend limiter increases, the radius of curvature generally decreases, forming a smaller circle and representing an increased bend. This is quantitatively indicated, for example, by the distance from the center of the circle C″ to the axis 335″ being less than the distance from the center of circle C′ to the axis 335′, as the radius of curvature decreases respectively from r′ to r″. The radius of curvature r′, r″ of the optical fiber is thus related to the lateral force applied to the combined bend limiter/optical fiber (which equals and is opposed by the bend resistance provided by the combined deflected bend limiter/optical fiber). Increasing the force applied to the optical fiber thus decreases the radius of curvature of the bend limiter. Using the bend limiter therefore increases the force necessary to bend the bend limiter beyond its maximum bend limit. Bending the optical fiber above the maximum bend limit would likely overstress and damage the optical fiber.

The inner bore 31 is that region within the cylindrical shape 328 formed by the lines 330. The length of the inner bore 31 accommodates the length of the optical fiber 1. The optical fiber 1, in one embodiment, extends relatively loosely within the inner bore 31, and the spirally extending coil 32 extends coaxially around the optical fiber 1. The spring 30 has sufficient lateral bending resistance to limit the bending of the optical fiber 1, resulting from application of some prescribed lateral force to the spring 30, to within the maximum bend limit of the fiber. The spring 30 of the bend limiter 300 is not shown as secured to the package 22, though it may or may not be secured to the package. If the spring 30 is secured to the package 22, the bend limiter 300 limits the bending of the optical fiber 1 adjacent to where the optical fiber enters (or exits) the package. Alternatively, the spring 30 may limit the bending of the optical fiber 1 at some location remote from a package. For instance, an entire length of an optical fiber can have a bend limiter 300 formed thereabout.

The spring 30 of the bend limiter 300 has a designed lateral spring factor (K). For springs, in general, the term “spring factor” typically applies to either axial compression or axial tension of the spring. The term “spring factor” for the spring 30 of the bend limiter in this disclosure, however, relates to lateral bending of the spring 30. The lateral spring factor (K) of the spring 30 determines the bend resistance of the optical fiber under a laterally applied force against the fiber and/or spring 30 (i.e., a bending force applied to the spring). The relative effectiveness of the lateral spring factor (K) in a spring depends on several design factors including the material of the spring 30, the thickness of the coil 32, the cross-sectional configuration of the coil 32, and the overall configuration of the spring 30. The lateral spring factor is a function partially of the pitch of the spring 30. The pitch of the spring 30 measures the axial distance between adjacent coils 32. If the pitch varies along the length of the spring 30 forming the bend limiter 300, then the lateral spring factor also varies along the length of the bend limiter 300.

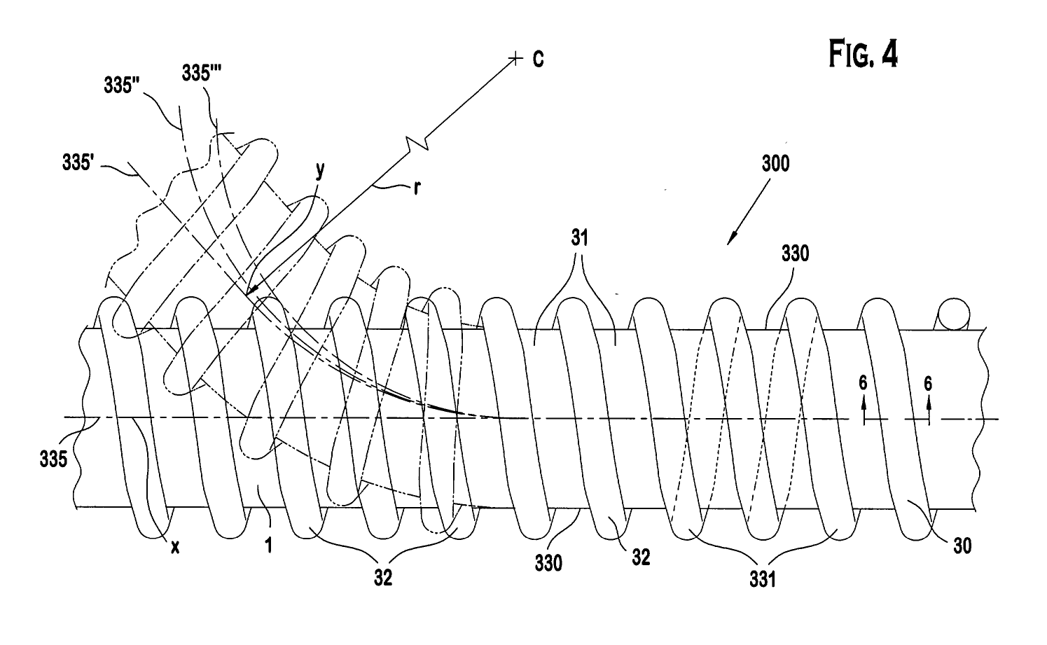

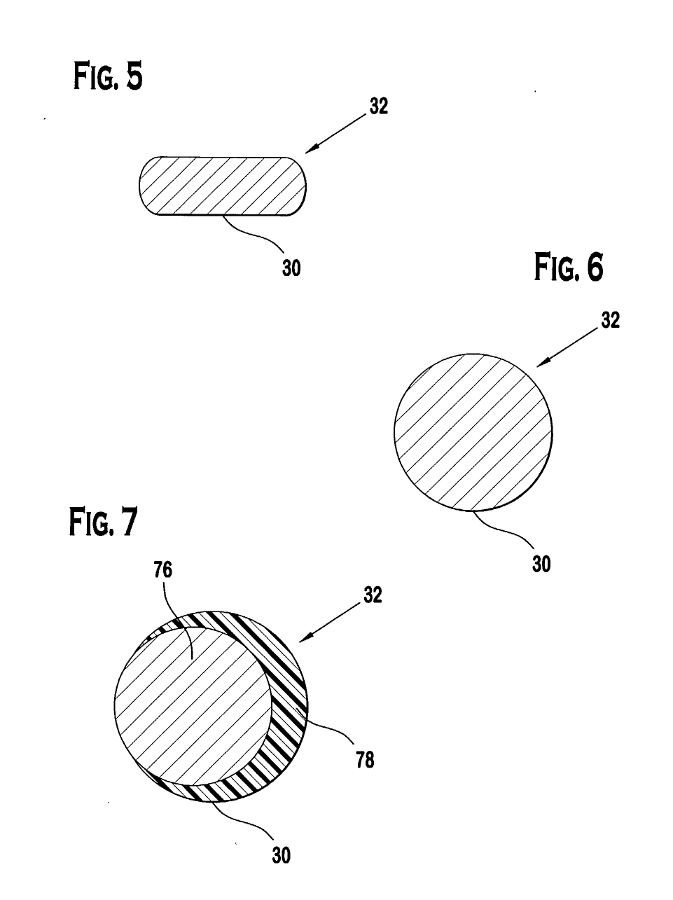

As shown in FIGS. 3 and 4, the elongated spring 30 can have variations with respect to its thickness as it utilizes spiral coils with multiple thickness variations. It is possible to provide varying bending resistance to the optical fiber 1 by varying the coil thickness. An embodiment shown in FIG. 3 includes a relatively thin spirally extending coil 32 to provide controllable resistance against bending force of the optical fiber. The shape of the embodiment of spring 30 illustrated in FIG. 5 has a relatively flat and thin spirally extending coil 32.

FIG. 4 shows another embodiment of the spring 30 that includes a spirally extending coil 32 that is substantially circular in cross section. The FIG. 4 embodiment of bend limiter provides a greater resistance against lateral bending of the optical fiber 1 than the embodiment shown in FIG. 3. That is, the radius of curvature, as measured by the radius r from the center of the circle C, is more for a similar applied lateral force than that of the embodiment shown in FIG. 3. As shown in FIG. 6, the spirally extending coil 32 in the embodiment of FIG. 4 is relatively thick and round. In this embodiment, the bend force exerted on the optical fiber 1 is considerable. As such, different embodiments of bend limiter provide a wide range of bend resistance control of the optical fiber.

The spring bend limiter should be electrically non-conductive, so that it cannot short to other electronic components mounted in close proximity. Examples of such electronic components as transistors, op-amps, etc. as well as certain optical components. Additionally, making the bend limiter 300 non-conductive limits electrically shorting the package 30, and the components therein. Thus, the spring 30 typically includes a non-electrically conductive material (or has a non-electrically conductive coated surface) having a suitable lateral spring factor as described herein. For example, the spring 30 can be an electrically insulating material such as plastic or elastomeric. The coil 32, shown in cross-section in FIG. 5, is formed entirely from an electrically insulative material. Certain embodiments of the spring 30 may include metals or other electrically conductive materials. For instance, a metal spring 30 may provide a desired level of bend resistance or radius of curvature and/or longer lifetime. FIG. 6 shows a cross-sectional diagram of the coil 32 of the spring 30 formed entirely of metal. Metals, however, are electrically conductive.

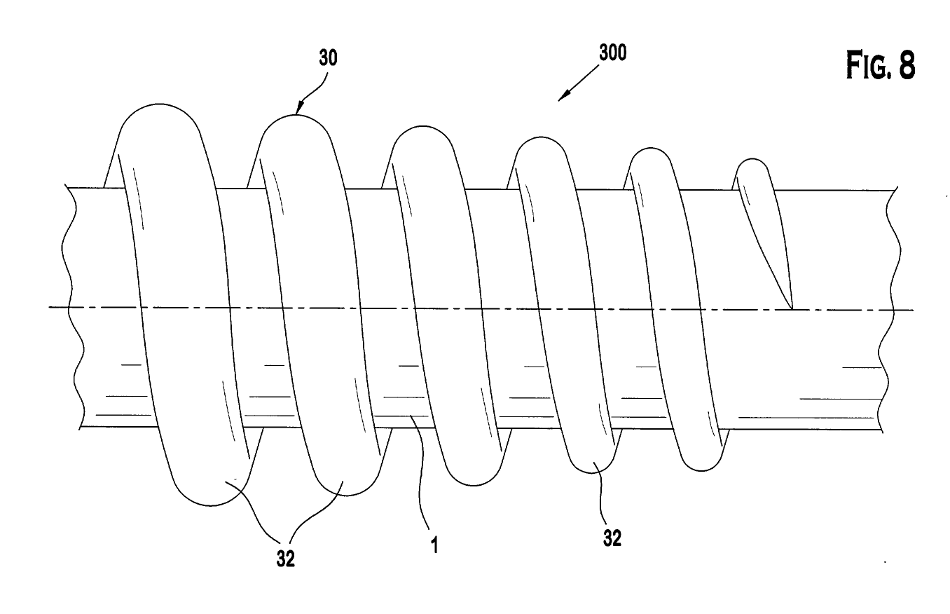

Thus, in another embodiment, the spring 30 can be formed primarily of metals or related materials in metal section 76, and a portion of (or the entirety of) the spring 30 can be coated using an electrically insulating material such as a coating 78 formed including polymer, an elastomeric, or an oxide. The spring 30 in FIG. 7, for instance, is formed primarily of a metal. An elastomeric coating 78 coats the metal providing the electric insulation. Alternatively, the entire outer surface of the spring may be coated. The embodiments described herein describe the spring 30 as having coils.

The present disclosure describes a variety of spring configurations, each configuration is designed to provide a desired lateral spring factor (K). Certain springs are configured without coils. For example, one embodiment of spring includes a substantially cylindrical homogenous device having the desired lateral spring factor. FIGS. 3 and 4 each show an embodiment in which a spirally extending coil 32 axially extends around the optical fiber 1. The thickness of the coil 32 is even and consistent from one longitudinal axis to another. Because of this configuration, unlike prior type bend limiters as shown in FIGS. 1 and 2, the coil 32 provides a consistent and even bending resistance from one longitudinal axis to another. That is, the coil 32 limits forces applied to the optical fiber 1 evenly for the entire length of the spring 30 from one end to another. As shown in FIGS. 3 and 4, the spring 30 is substantially uniformly constructed along its cross-sectional axial length. As such, the coil dimensions are substantially consistent, the materials of the spring are consistent, and the lateral spring factor (K) is therefore consistent. Such uniformity of spring along its length provides a substantially uniform bending resistance along the length of the spring.

In certain embodiments of bend limiters, it is desired to have the bending spring factor of the bend limiter 300 greater at the mounting end 23 than the fiber end 24. The cross-sectional dimension of the spirally extending coil 32 thus generally decreases along the length of the bend limiter 300 from the mounting end 23 to the fiber end 24 in certain embodiments of bend limiter. Alternatively, the pitch of the spring 30 increases from the mounting end 23 to the fiber end 24. Such decreasing of the cross-sectional dimension (or changing the pitch) results in a slightly varied lateral spring factor K along the length of the bend limiter 300. A varied spring factor K may be useful where a greater bending force is applied to the bend limiter adjacent the mounting end than adjacent the fiber end.

It is therefore understood that for certain applications, it may be desired to provide an embodiment of bend limiter 300 having a spring 30 that is not uniform along its length. Additionally, perhaps it may be desired to provide an increased bend resistance at a location adjacent to the mounting end where the bend limiter is mounted to the package so the bending of the optical fiber is limited most in this region adjacent to the bend limiter. Providing larger coils at the mounting end may also be desired to enhance mounting the bend limiter to the package using, for epoxy, mechanical fasteners, etc. since larger coils may more easily be secured to packages in certain embodiments of bend limiters. In the embodiment of bend limiter 300 shown in FIG. 8, the elongated spring 30 has a spirally extending coil 32, which comprises varying thickness. The thickness of the coil 32 in the fiber end is relatively thin, and it gradually increases towards the mounting end. The variation of the width of the coil affects the bend resistance along the axial length of the spring. Because of this configuration, the bending resistance afforded to the optical fiber 1 changes along the longitudinal axis.

One embodiment of the minimum outer diameter of the spring bend limiter, using current manufacturing techniques, is 0.05 inches. There is no corresponding maximum dimension. The potential ranges of the dimensions of the spring bore is based largely on the outer diameter of the spring. The maximum deflection of typical commercially available optical fibers is approximately 1.0 inch. This 1.0 inch deflection corresponds to a 1.1 Kg “side load pull” on the optical fiber. Different optical fibers 1 having different dimensions may take on different radii of curvatures in response to a given applied lateral force. For springs in general, spring calculations are based on axial tension and/or axial compression. The deflection to the bend limiter in this disclosure relates to off-axis forces that produce axial tension on one lateral side of the spring and axial compression on the other lateral side of the spring. No standard spring calculations have been found to describe off-axis loads applied to the spring. Spring material, cross-sectional geometry of the coils, and coil pitch have a major impact on the bending characteristics of the spring.

II. Package Configurations

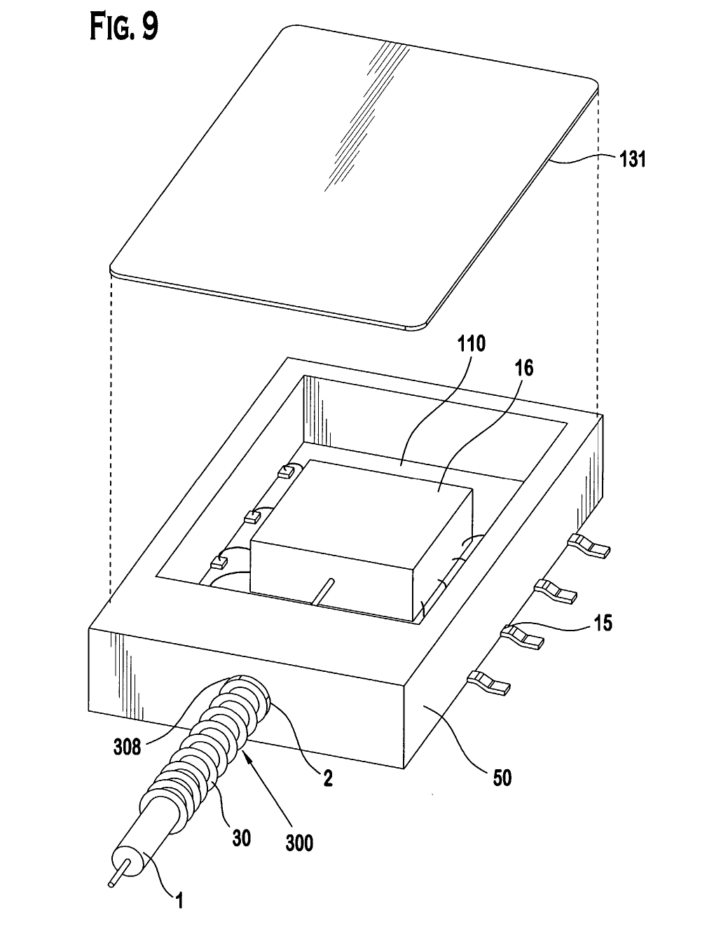

The bend limiter 300 may protect either free lengths of optical fiber remote from an optical package or lengths of optical fiber that pass through an optical package. In the latter configuration, a package 50 is a structure containing an optical device connected to an optical fiber. One application of the bend limiter limits the bending of an optical fiber entering (or exiting) the package 50. One embodiment of bend limiter apparatus 310 includes the package 50 and the spring 30 as shown in FIG. 9. The optical fiber 1 extends from the external of the package 50, through the spring 30, then through the aperture 2 into the interior of the package 50. The elongated spring 30 extends through the aperture 2 formed in the package 50. The aperture 2 firmly secures the spring 30 in the package. The package 50 can accommodate a variety of springs 30 forming bend limiters. Spring 30 can vary with such factors as thickness, material, pitch dimension, and coil configuration. Designing to these factors largely determines the spring constant of the spring 30 of the bend limiter 300. The package 50 includes a mounting device 308 that secures the spring 30 to the package 50. Certain embodiments of mounting device includes epoxy, a fastener, a mechanical tab, an adhesive, or other restraint that may be formed on the package 50 to secure the spring 30 in position relative to the package 50. Additionally, welding, brazing, or soldering can secure the spring 30 to the package 50.

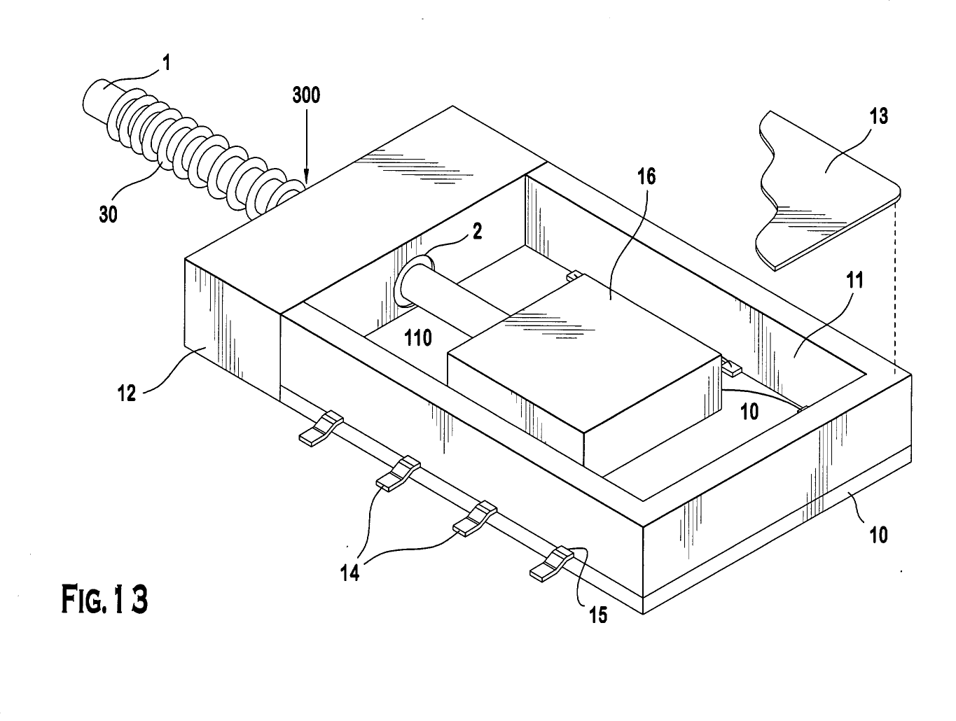

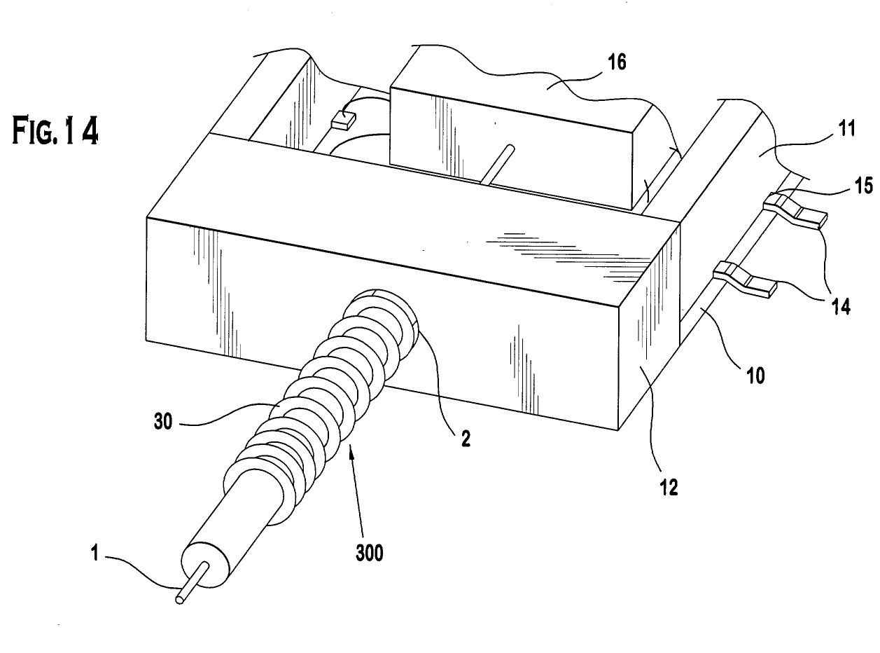

Many package 50 embodiments may be used. For example, FIG. 9 shows one embodiment of package 50 with a cavity 110. The optical device 16 fits into, and connects to the edges of, the cavity 110. A lid 13 of the package fits over, and connects to, the remainder of the package 50 so the cavity 110 forms an enclosure, defined within the package 50 and the lid 13. Another embodiment of package 50 includes a number of integrated components, as shown and described herein relative to FIGS. 13 and 14. Such integrated components include, for example, a baseplate 10, a backbone 12, a ceramic wall portion 11, and the lid 13. Regardless of the number of components associated with the package 50, the package forms a cavity 110 to encase the optical device. Additionally, the optical fiber 1 can extend through the aperture 2 in the package. As shown further in FIG. 9, the optical fiber 1 fits through the inner bore of the elongated spring 30. The optical fiber 1 therefore extends from external the package via the aperture 2 formed in the package 50 to the optical device 16 mounted in the package 50. The optical fiber operatively connects to the optical device 16. The optical device 16 in certain embodiments is connected to other electrical components using the electrical leads 14. Multiple electrical leads channels 15 formed in the package 50 provide the electrical leads 14.

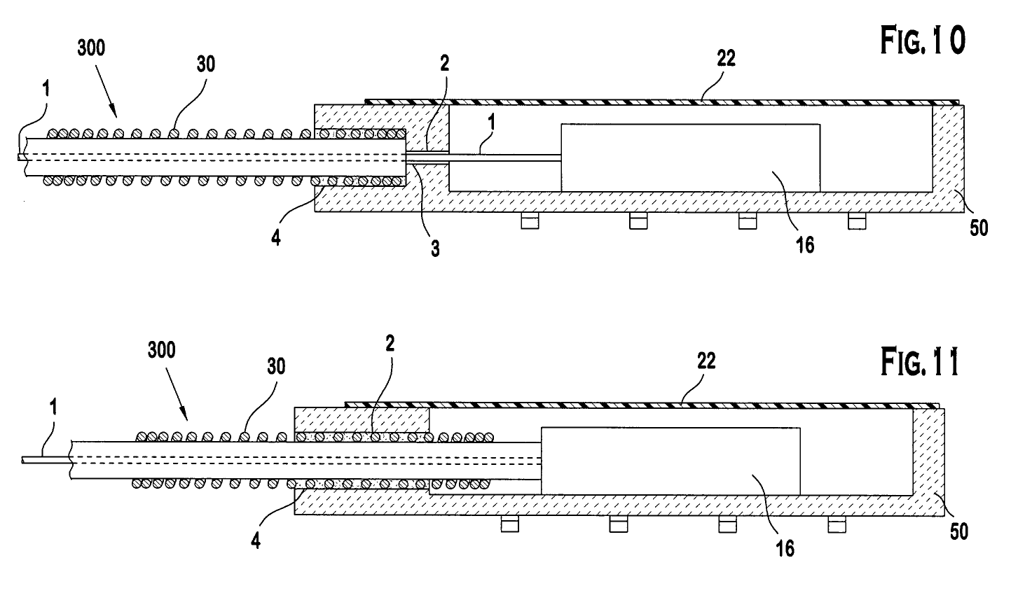

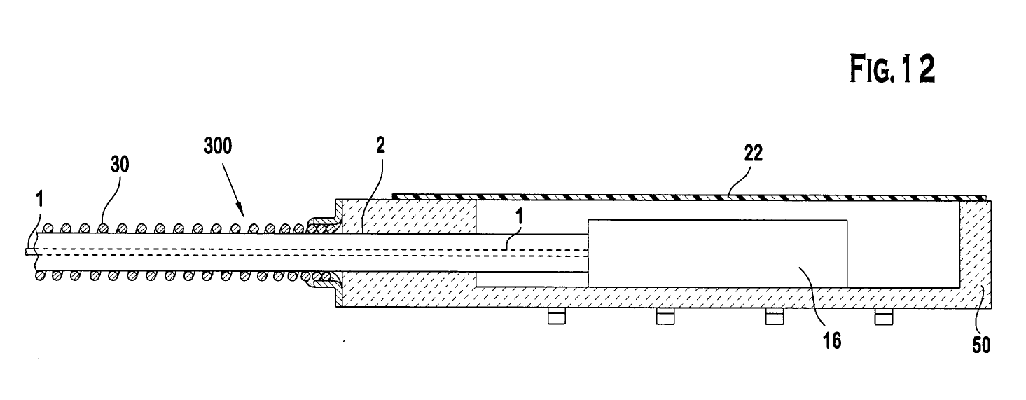

FIGS. 10-12 show side cross-sectional views of multiple embodiments of package 50 that include a bend limiter 300. In the embodiment of package 50 shown in FIG. 12, the aperture 2 of the package 50 directly accommodates the optical fiber 1 without using any bend limiter. Here, the optical fiber 1 extends from outside the package 50 directly through the aperture 2 to inside of the package where the optical fiber 1 connects to the optical device 16.

FIG. 10 shows another embodiment of bend limiter that fits within an aperture 2. The aperture 2 comprises a counter bore 4 and a fiber bore 3. The counter bore 4 has a larger diameter than the fiber bore 3. The outside diameter of the spring 30 is less than the diameter of the counter bore 4, yet greater than the diameter of the fiber bore 3. With this package configuration, the spring 30 is fitted into, and may be secured within, the counter bore 4, and extends out externally out of the counter bore 4 to limit the bending of the optical fiber 1 exiting the package 50.

FIG. 11 shows one embodiment of bend limiter including the aperture 2 that accommodates the spring 30, wherein the spring 30 provides a bending resistance to the optical fiber 1. Here, the spring 30 that defines the bend limiter 300 extends through the entire length of the aperture 2. The spring 30 protrudes externally, thereby limiting bending resulting from lateral forces applied to the optical fiber 1. The spring 30 also protrudes internally in the package 50, thereby limiting the bending of the optical fiber 1 from any internal bending pressures.

FIG. 13 illustrates another embodiment of the package 50 comprising a backbone 12, the optical device 16, the optical fiber 1, the elongated spring 30, the ceramic wall portion 11, and the baseplate 10. The baseplate 10 can thus be made of a different material than the package 50. The optical device 16 may be mounted directly, or indirectly, on the baseplate 10. The lid 13 provides direct access to the optical device 16. In FIG. 13, unlike the package shown in FIG. 9, an aperture 2 is formed in the backbone 12. The backbone 12 attaches to the package 50. The backbone 12 integrally interfaces with the optical fiber 1, the spring 30, and the package 50. Thus, the optical fiber 1 extends out to the external from the optical device 16 through the aperture 2 formed in the backbone 12.

One technique to determine the proper dimension of the spring to be used in conjunction with the bend limiter is to initially design the spring based on the inner diameter of the spring 30, as shown in FIG. 1. The inner diameter of the spring 30 is based on, e.g., the outer diameter of the optical fiber 1 or electrical conductor. Commercially available optical fiber 1 has an outside diameter of 900 um (micrometers).

The dimension of the aperture 2 extending through the package 22 is then designed to be sufficiently large to accommodate the spring 30. The height of the package 22 (e.g., the backbone) can then be designed based on the designed largest diameter of the aperture. The package 22 has sufficient material above, and below, the aperture to form the mounting surface for the bend limiter.

The materials, diameter, and pitch of the spring 30 is then designed (based on the inner diameter of the spring and the dimension of the aperture) to provide the desired bending spring factor, and other spring parameters.

As shown in FIG. 13, the backbone 12 is adapted at attaching to the package 50. In this disclosure, the term “ceramic wall portion” 11 relates to a structure including ceramics that may be layered. The ceramic wall portion 11 may include metalization materials. One embodiment requires a relatively short backbone that is as tall, or shorter than the package. However, the bend limiter 300 can connect directly to the backbone. In any embodiment, the bend limiter 300 acts to limit the overall bending of the fibers to applied lateral bending forces. The backbone forms a portion of the package 50, and the backbone 12 mechanically connects to the baseplate 10, the lid 13, and the ceramic wall portion 11. The ceramic wall portion 11 facilitates connections between the optical device 16 and other electrical components. The optical device 16 connects to other electrical components with the electrical leads 14. One electric lead extends through each electrical lead channel 15 formed in the package 50. The embodiment shown in FIGS. 13 and 14 includes the ceramic wall portion 11 that has a plurality of ceramic layers. In another preferred embodiment, certain ones of the plurality of ceramic layers may be metalized to form electric traces and/or electric lends.

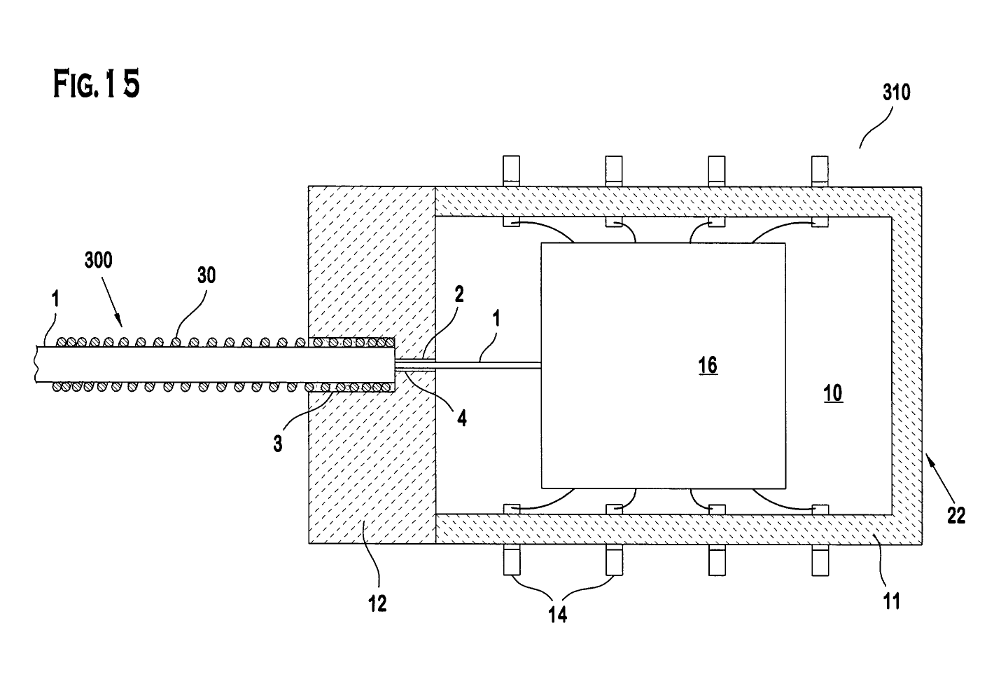

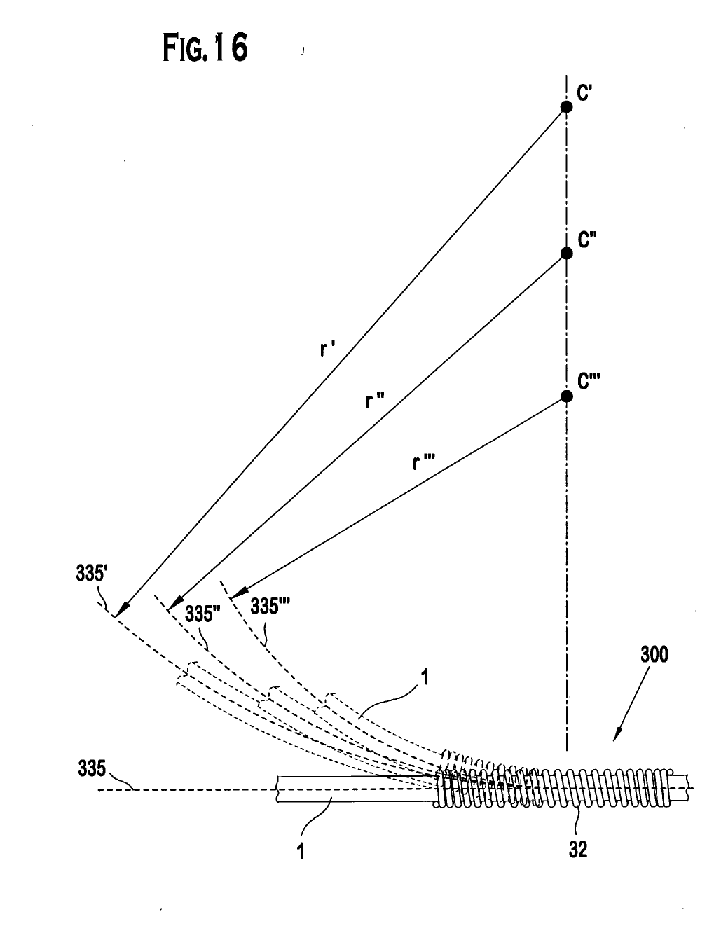

The backbone 12 is integrated into certain embodiments of package 50. The backbone 12 is adapted at accommodating the spring 30. Different embodiments of spring 30 have varied thickness, the materials, and the configurations. The spring 30 securely mounts in the aperture 2 formed in the backbone 12 in the embodiment of FIG. 15. Thus, the optical fiber 1 extends through the spring 30. The spring 30 fits into the aperture in the backbone 12. Because of this configuration, the bend limiter limits the bending of the optical fiber 1 to a prescribed amount (when a prescribed lateral force is applied to the optical fiber and/or the bend limiter). FIG. 15 is a cross-sectional view of one embodiment of bend limiter apparatus 310 showing the backbone 12 securely attached to the package. In the embodiments shown in FIGS. 10-12, the aperture 2 formed in the backbone 12 can have multiple variations. These variations apply whether the aperture extends through the backbone or any other package portion. In FIG. 15, the backbone 12 includes an aperture 2, which comprises a counter bore 3 and a fiber bore 4. The spring 30 fits in the counter bore 3 formed in the backbone 12. Certain embodiments of backbone include the fiber bore 4, but not the counter bore 3.

The backbone 12 provides a portion of the package that secures the optical fiber 1 and the spring 30 relative to the package. Some of the means for securing the optical fiber 1 include epoxy, welding, brazing, and soldering. In addition, some mechanical tab, fastener, adhesive, or other restraint may secure the spring 30 to the package 22. The fastener resists the spring 30 being pulled out of the package 22. In the embodiments without a counter bore where the bend limiter 300 is secured to the package 22, some other mechanism (such as a mounting device) affixes the bend limiter 300 to the package.

The backbone material should have good machinability characteristics and a coefficient of expansion that substantially matches the glass fiber. One embodiment utilizes an Invar-based metal. The backbone has to have a sufficiently large cross-sectional dimension to form a counter bore having a sufficient dimension to retain the fiber. Only certain materials can be drilled with such a small diameter hole, with the necessary precision, to form the aperture. The aperture 2 is relatively small to position the fiber within the package, for example. The spring bend limiter involves some delicate and complex machining largely because of the small dimension of the spring, the fiber bore, and the counterbore. The aperture can be formed with such precise drilling techniques as mechanical drilling, water jet, cutting/drilling, laser drilling, etc. A backbone 12 formed from a different material than the remainder of the package 22 allows the backbone material to be selected based on superior machinability; the materials of the other portions of the package to be formed based on other criteria. If the entire package is made from the same unitary material (as shown in the embodiment in FIG. 9), then the material of the entire package would have to be selected based on its excellent machinability. As such, the package would be more expensive, and certain characteristics other than machinability may not be optimized.

In one aspect, the outer diameter of the bend limiter (formed from an elongated spring) can be constructed much smaller than current bend limiter outer diameters for optical devices. Therefore, a miniaturized optical package can now incorporate a bend limiter of reduced size.

Although the present invention has been described in connection with specific exemplary embodiments, it should be understood that various changes, substitutions, and alterations could be made to the disclosed embodiments without departing from the spirit and scope of the invention as set forth in the appended claims.

What is claimed is:

1. A bend limiter for interfacing with an elongated optical fiber to limit bending of the optical fiber, comprising:
an elongated spring including a spirally extending coil, said spirally extending coil at least partially defining an inner bore, said inner bore adapted to accommodate said optical fiber such that said spirally extending coil extends coaxially around said optical fiber, wherein said spring provides bending resistance that limits the bending of said optical fiber.

2. The bend limiter as claimed in claim 1, wherein said spring has a prescribed lateral spring factor (K) that controls the bending resistance, wherein said lateral spring factor is determined based upon one from the group of the material of the spring, the thickness of said spirally extending coil, or the configuration of said spirally extending coil of said spring.

3. The bend limiter as claimed in claim 1, wherein said spring has a longitudinal axis, wherein said spring is configured to provide the bending resistance in a direction taken transverse to the longitudinal axis that changes along said longitudinal axis.

4. The bend limiter as claimed in claim 1, wherein said spring is formed at least partially of material from the group of plastic, metal, and elastomeric material.

5. The bend limiter as claimed in claim 1, wherein said spirally extending coil provides a desired bending resistance to said optical fiber.

6. A bend limiter for interfacing with an elongated optical fiber to limit bending of the optical fiber, comprising:
a package including at least one aperture formed therein;
an elongated spring including a spirally extending coil, said spirally extending coil at least partially defining an inner bore, said inner bore adapted to accommodate said optical fiber such that said spirally extending coil extends coaxially around said optical fiber, wherein said spring provides bending resistance that limits the bending of said optical fiber; and
wherein said spring is adapted to fit within said at least one aperture such that said optical fiber enters and/or exits said package through said at least one aperture.

7. The bend limiter as claimed in claim 6, wherein said package includes a backbone, wherein said at least one aperture is formed in said backbone.

8. The bend limiter as claimed in claim 6, wherein said at least one aperture comprises a counter bore and a fiber bore, wherein said counter bore is substantially colinear with said fiber bore, and wherein a diameter of said counter bore is greater than a diameter of said fiber bore.

9. The bend limiter as claimed in claim 8, wherein said spring is adapted to fit within said counter bore.

10. The bend limiter as claimed in claim 6, wherein said spring has a prescribed lateral spring factor (K) that controls the bending resistance, wherein said lateral spring factor is determined based upon one from the group of the material of the spring, the thickness of said spirally extending coil, or the configuration of said spirally extending coil of said spring.

11. The bend limiter as claimed in claim 6, wherein said package includes a baseplate.

12. The bend limiter as claimed in claim 6, wherein said package includes a lid.

13. The bend limiter as claimed in claim 6, wherein said package includes at least one ceramic wall portion.

14. The bend limiter as claimed in claim 13, wherein said ceramic wall portion includes a plurality of ceramic layers.

15. The bend limiter as claimed in claim 14, wherein said plurality of ceramic layers are metalized.

16. The bend limiter as claimed in claim 6, wherein said spring has a longitudinal axis, and the bending resistance changes along said longitudinal axis.

17. The bend limiter as claimed in claim 6, wherein said spring is formed at least partially of material from the group of plastic, metal, and elastomeric material.

18. The bend limiter as claimed in claim 6, wherein said spirally extending coil provides a desired bending resistance to said optical fiber.

19. The bend limiter as claimed in claim 6, further comprising means for securing said spring to said at least one aperture.

20. An apparatus comprising:
a package including at least one aperture formed therein;
an optical fiber entering and/or exiting said package through said at least one aperture; and
a bend limiter that limits bending of the optical fiber entering and/or exiting said package through said at least one aperture, said bend limiter fitted in said at least one aperture, said bend limiter comprising:
an elongated spring including a spirally extending coil, said spirally extending coil at least partially defining an inner bore, said inner bore adapted to accommodate said optical fiber such that said spirally extending coil extends coaxially around said optical fiber, wherein said spring provides bending resistance that limits bending of said optical fiber entering and/or exiting said package through said at least one aperture.

21. The apparatus as claimed in claim 20, further comprising an optical device, said optical device fixedly mounted on said package.

22. The apparatus as claimed in claim 21, wherein said optical fiber is operatively connected to said optical device.

23. The apparatus as claimed in claim 20, wherein said spring has a prescribed lateral spring factor (K) that controls the bending resistance, wherein said lateral spring factor is determined based upon one from the group of the material of the spring, the thickness of said spirally extending coil, or the configuration of said spirally extending coil of said spring.

24. The apparatus as claimed in claim 20, wherein said package includes a baseplate for fixedly mounting an optical device thereon.

25. The apparatus as claimed in claim 20, wherein said package includes a lid.

26. The apparatus as claimed in claim 20, wherein said package includes a backbone, wherein said at least one aperture is formed in said backbone.

27. The apparatus as claimed in claim 20, wherein said at least one aperture comprises a counter bore and a fiber bore, wherein said counter bore is substantially colinear with said fiber bore, and wherein a diameter of said counter bore is greater than a diameter of said fiber bore.

28. The apparatus as claimed in claim 27, wherein said spring is adapted to fit within said counter bore.

29. The apparatus as claimed in claim 20, wherein said package includes at least one ceramic wall portion.

30. The apparatus as claimed in claim 29, wherein said ceramic wall portion includes a plurality of ceramic layers.

31. The apparatus as claimed in claim 30, wherein said plurality of ceramic layers are metalized.

32. The apparatus as claimed in claim 20, wherein said spring has a longitudinal axis, and the bending resistance changes along said longitudinal axis.

33. The apparatus as claimed in claim 20, wherein said spring is formed at least partially of material from the group of plastic, metal, and elastomeric material.

34. The apparatus as claimed in claim 20, wherein said spirally extending coil provides a desired bending resistance to said optical fiber.

35. The apparatus as claimed in claim 20, further comprising means for securing said spring to said at least one aperture.

36. A method for interfacing with an elongated optical fiber to limit bending of the optical fiber, comprising:
positioning an elongated spring including a spirally extending coil around an elongated optical fiber, said spirally extending coil at least partially defining an inner bore, said inner bore adapted to accommodate said optical fiber such that said spirally extending coil extends coaxially around said optical fiber;
wherein said elongated spring limits the bending of said optical fiber to within a maximum bend limit when a prescribed lateral force is applied to the elongated spring.

37. The method as claimed in claim 36, wherein said spring has a prescribed lateral spring factor (K) that controls a bending resistance of said elongated spring.

38. The method as claimed in claim 37, wherein said spring has a longitudinal axis, and the bending resistance changes along said longitudinal axis.

39. A method for limiting bending of an optical fiber using a bend limiter, comprising:
providing a package having at least one aperture formed therein;
providing an elongated spring including a spirally extending coil, said spirally extending coil at least partially defining an inner bore;
positioning said optical fiber in said inner bore wherein said spirally extending coil extends coaxially around said optical fiber;
wherein the elongated spring provides bending resistance that limits the bending of said optical fiber; and
wherein the spring fits within said at least one aperture such that said optical fiber enters and/or exits said package through the at least one aperture.

40. The method of claim 39, wherein said spring has a prescribed lateral spring factor (K) that controls the bending resistance, wherein the lateral spring factor is determined based upon one from the group of the material of the spring, the thickness of said spirally extending coil, or the configuration of said spirally extending coil of said spring.

41. A bend limiter that limits the bend radius of an optical fiber, the bend limiter comprising an elongated spring having an outer diameter that is less than or equal to 0.05 inches.

42. The bend limiter of claim 41, wherein the elongated spring deflects approximately 1.0 inch upon application of a 1.1 Kg side load pull.
